(19) United States
(12) Patent Application Publication
(10) Pub. No.: US 2009/0261123 A1
(43) Pub. Date: Oct. 22, 2009

(54) PUMP ASSEMBLY WITH SOUND EMITTING DEVICE

(75) Inventors: Eric J. McNiff, Gloucester, MA (US); Christopher G. Rowen, Rockport, MA (US)

Correspondence Address: CHRIS A. CASEIRO, VERRILL DANA, LLP, ONE PORTLAND SQUARE, PORTLAND, ME, 04112-0586, US

(73) Assignee: INTERNATIONAL PRODUCT SOLUTIONS, INC., Gloucester, MA (US)

(21) Appl. No.: 12/492,521

(22) Filed: Jun. 26, 2009

Related U.S. Application Data
(63) Continuation-in-part of application No. 11/881,784, filed on Jul. 30, 2007.

(51) Int. Cl. B67D 5/00

(52) U.S. Cl. 222/39

(57) ABSTRACT

A sound emitting fluid dispenser includes an actuation mechanism with a lever arm. The dispenser includes a pliable cap arranged to enable a user to apply localized force that causes movement of the lever arm in a direction that establishes an electrical connection. When the electrical connection is established, a sound emitting circuit is created and sound is generated. At the same time, the fluid is dispensed from the container.

### CROSS REFERENCE TO RELATED INVENTION

The present application is a continuation-in-part of, and claims the priority benefit of, pending application Ser. No. 11/881,784, filed Jul. 30, 2007, entitled “Pump Assembly With Sound Emitting Device.” The entire contents of that priority application are incorporated herein by reference.

### FIELD OF THE INVENTION

This invention relates to a pump assembly having a hand activated sound emitting circuit.

### BACKGROUND OF THE INVENTION

Pressurizing pump sprayers commonly utilize an integral cylinder and plunger arrangement to generate pressure and to expel a fluid such as soap from a container. Pressurizing pump sprayers are desirable in that they do not utilize pressurized containers which must be handled carefully and at controlled temperatures to avoid the risk of explosion. Pressurizing pump sprayers have a number of other advantages, including not using propellants which destroy the ozone and being relatively inexpensive.

There are two common varieties of pressurizing pump sprayers those that are pressurized on the upstroke and those that are pressurized on the down stroke. Pump sprayers that are pressurized on the down stroke typically utilize a return spring which biases the plunger upward after the pressurization stroke. Such pump sprayers are commonly utilized with a hand held container to dispense liquid skin care products such as liquid soap or skin moisturizer.

It is common experience that children avoid washing their hands prior to eating or subsequent toilet activity. In addition, containers for liquid soap having a down stroke pump sprayer can be easily manipulated by children.

Accordingly, it would be desirable to provide a container for a liquid such as soap which includes a feature that would encourage children to use it. Such a feature would promote hygiene of children during common activities such as dining or interacting with other children. The feature must be configured to ensure that children can operate it.

### SUMMARY OF THE INVENTION

The present invention provides a pressurizing pump sprayer having a sound emitter system that is activated when the pump sprayer is activated such as when applying pressure by hand. The present invention also provides an apparatus comprising a container for a liquid to be dispensed and the pressurizing pump sprayer which, when activated, emits a sound and dispenses liquid from the container to a point of use of the liquid. The sound emitter is positioned into the portion of the pump sprayer which is contacted by the user to activate the pump sprayer. The sound emitter includes a power supply, a circuit board, a sound chip, a sound emitting device and an activation switch. In an embodiment of the invention, the pump sprayer includes a pliable cap and a lever configured activation mechanism.

### BRIEF DESCRIPTION OF THE DRAWINGS

FIG. 1 is a perspective view of the container and pump sprayer of a first embodiment of the present invention.

FIG. 2 is a cross-sectional view of the apparatus of FIG. 1 in use.

FIG. 3 is an exploded perspective view of the first embodiment of the present invention.

FIG. 4a is a bottom perspective view of the switch of the first embodiment of the invention.

FIG. 4b is a cross-sectional view of the switch of FIG. 4a when it is not depressed.

FIG. 4c is a cross-sectional view of the switch of 4a when depressed.

FIG. 5 is a cross sectional view of the sound emitting device of FIG. 3 without connecting wires.

FIG. 6 is a bottom view of the plate housing for the first embodiment of the invention.

FIG. 7a is a side view of the housing of the pump dispenser of the first embodiment of the invention.

FIG. 7b is a cross-sectional view of the housing of FIG. 7a, showing the actuation and sound emitting components of the invention contained within the housing.

FIG. 8a is an exploded view of a sound emitting device of this invention attachable to a plate of a pump dispenser of this invention.

FIG. 8b shows the sound emitting device of FIG. 5a positioned on a plate of a pump dispenser.

FIG. 9 is an exploded perspective view of a second embodiment of the present invention.

FIG. 10 is a partially exploded perspective view of the second embodiment of the present invention.

FIG. 11 is a side view of the actuation mechanism of the second embodiment of the present invention.

FIG. 12 is a perspective view of the second embodiment of the present invention, showing the flexible partial compression of the pliable cap containing the actuation mechanism.

### DESCRIPTION OF SPECIFIC EMBODIMENTS

In accordance with this invention, a pressurizing pump dispenser includes a sound emitting device secured to a container for a liquid to be dispensed. The pump dispenser can be detached from the container and then attached to a second container, usually after the liquid in the first container is depleted. The invention also includes the combination of a container for a liquid attached to a pump dispenser as described herein. A second embodiment of the invention includes an alternative actuation mechanism and a pliable housing.

The sound emitting device of this invention includes a hand activated switch and a sound emitter that is activated by the switch. The sound emitter and switch are positioned in or on a plate which can be depressed by hand to activate the pump dispenser. The sound emitter emits a sound such as a voice message, for example a voice message which encourages the use of the pump dispenser.

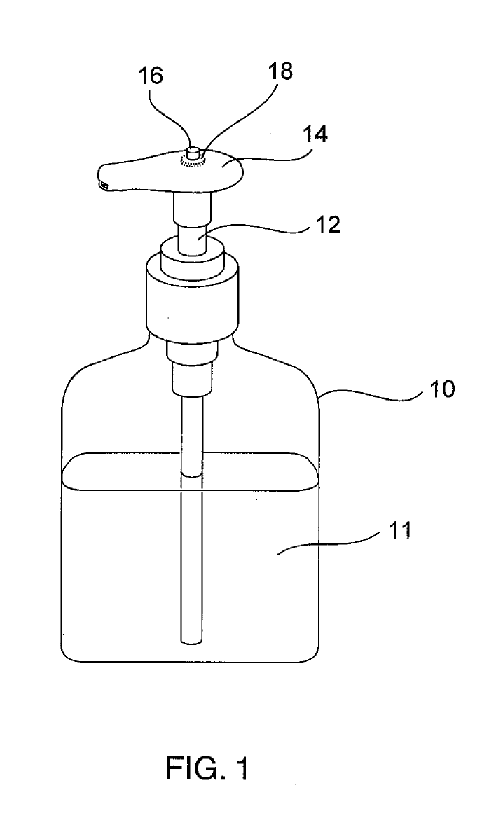

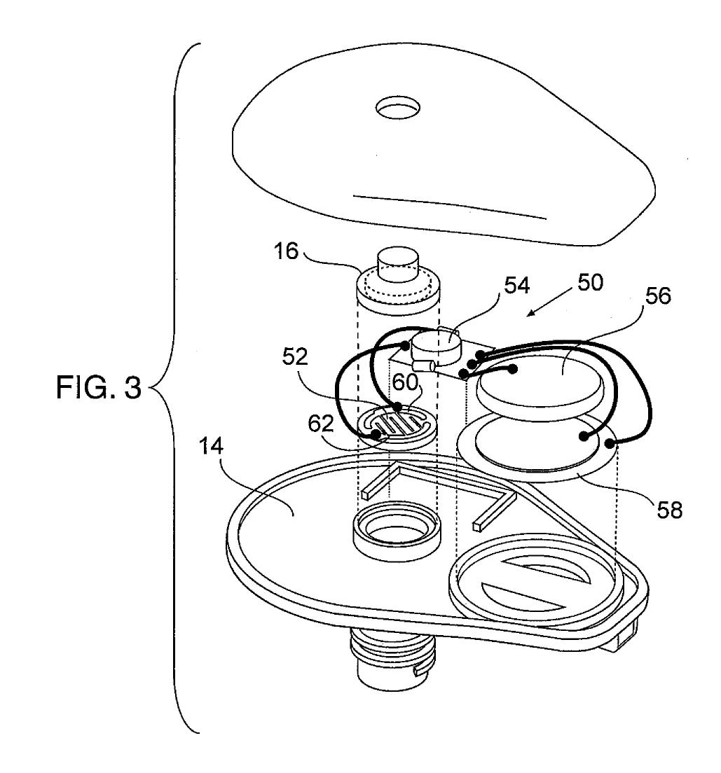

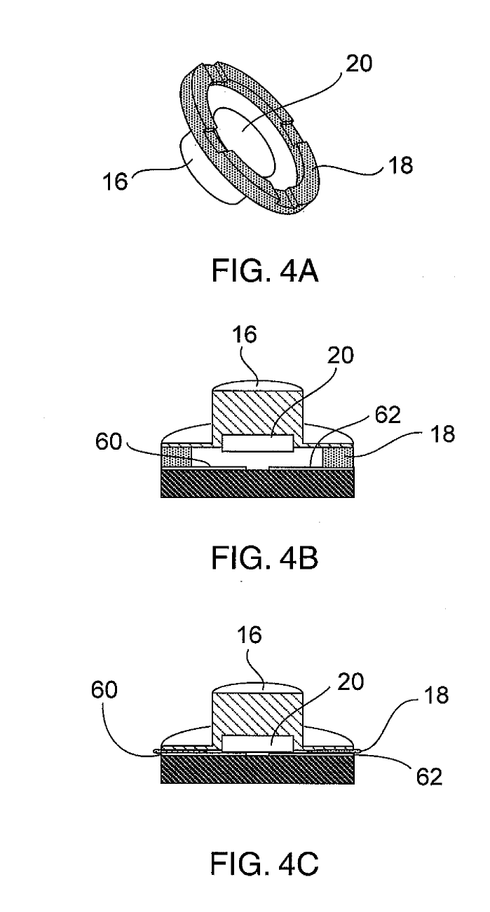

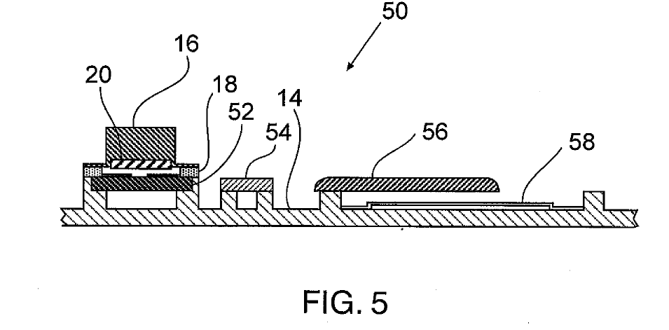

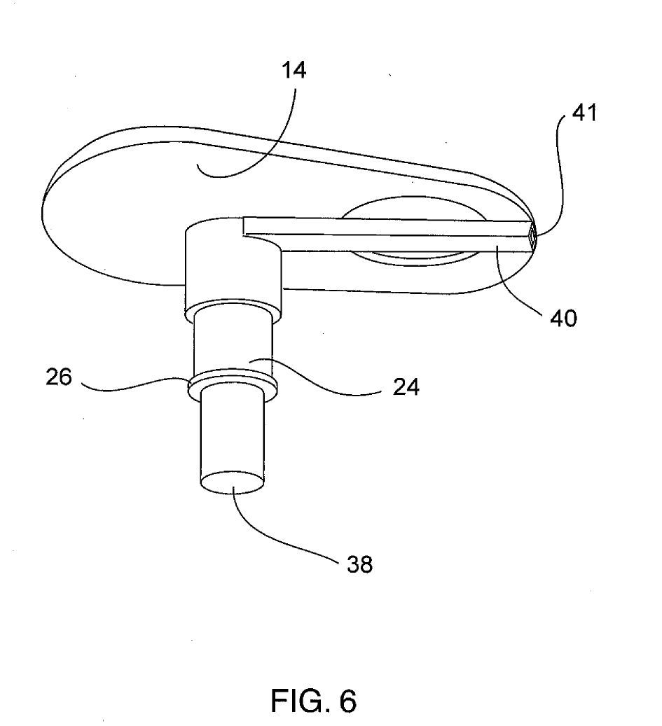

Referring to FIG. 1, the combination of a container 10 for a liquid 11 to be dispensed and the pressurizing pump dispenser 12 is shown. The container 10 in FIG. 1 is shown as a transparent container. The pump dispenser 12 includes a plate 14 to which is secured an activation switch 16 having a flexible housing 18. The activation switch 16 is activated by hand when the user contacts the switch 16 to depress the plate 14. The pressure applied to depress the plate 14 compresses housing 18 (FIG. 4c) to move the switch 16 downwardly to contact poles 60 and 62 of battery 52 (FIG. 3) and activate a sound emitting device 56 and 58 (FIG. 3) positioned within plate 14. The switch 16 includes a metal contact 20 (FIGS. 4a, 4b, 4c and 5) positioned within flexible housing 18. When the hand of the user is applied to the switch 16, the flexible housing 18 contracts to permit contact of the metal contact 20 with the poles 60 and 62 (FIG. 4c). When the hand of the user is removed from the switch 16, the flexible housing 18 (FIG. 4b) expands so that the metal contact 20 is removed from contact with the poles 60 and 62 of sound emitting device.

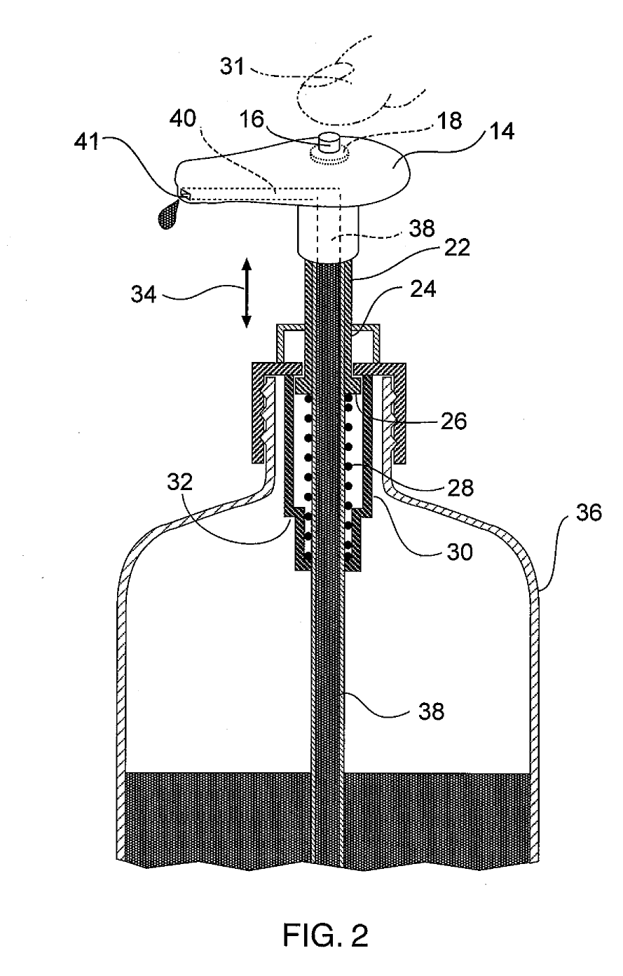

Referring to FIG. 2, the plate 14 is mounted on the upper end 22 of the conduit 24. The conduit 24 is provided with a movable flange 26 secured thereto. The movable flange 26 and spring 28 are positioned within housing 30. Housing 30 is provided with a stop flange 32. The conduit 24 is movable vertically as indicated by arrow 34 between the position shown and to the position wherein the spring 36 is fully compressed by hand pressure provided by finger 31 between movable flange 26 and stop flange 32. When container 36 contains liquid, liquid is pumped through fluid pathways 38 and 40 which are in fluid communication with each other and out outlet 41. When hand pressure is released, the conduit 24 returns to the position shown in FIG. 2. During the time hand pressure is applied to switch 16, compressible housing 18 is compressed to move the switch 16 into contact with a sound emitting device 50 (FIG. 3) positioned within plate 14. The structure of the sound emitting device will be explained below with reference to FIGS. 3 and 5.

Referring to FIGS. 3 and 5, the sound emitting device 50 of the invention which is positioned within plate 14 is shown. The sound emitting device 50 includes a battery 52, a circuit board 54, a sound chip 56 such as a chip that stores sound digitally and a speaker, vibrating filament or the like 58 which are electronically connected to each other. The battery 52 has a positive pole 60 and a negative pole 62 which are not connected initially. Electrical connection of the poles 60 and 62 is effected by switch 16 when it is depressed by a user to contact poles 60 and 62. The circuit board 54 functions to receive and store electrical power from battery 52 and to provide electrical current to sound chip 56 for a desired time period, typically from about 2 to about 10 seconds. The sound chip 56 is programmed to deliver a desired audio message to speaker; vibrating filament or the like 58 which emits the desired audio message to the user of the device. By operating in this manner, a desired audio message is delivered to the user in response to the user's depressing switch 16. Any audio message can be programmed into the sound chip 56 as desired.

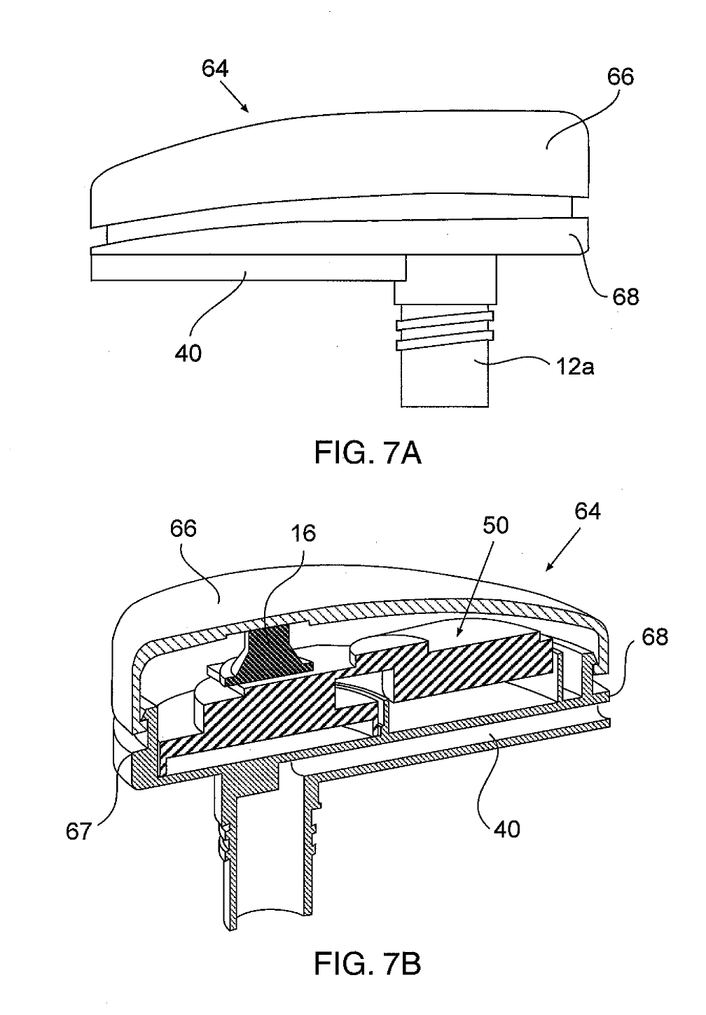

Referring to FIGS. 7a and 7b an embodiment of this invention is shown wherein the switch 16 is positioned within a housing for the sound emitting device 50. The housing 64 is formed of a top section 66 and a bottom section 68 which are snap fit together to house switch 16 and sound emitting device 50. Housing 64 is secured to pump dispenser 12a which functions in the same manner as pump dispenser 12. Switch 16 and sound emitting device 50 operate in the manner as set forth above. When pressure is applied to top section 66, it moves downwardly to contact flange 67 and to compress activation switch 16 (FIG. 4c). When pressure is removed from top section 66, switch 16 returns to the position shown in FIG. 4b.

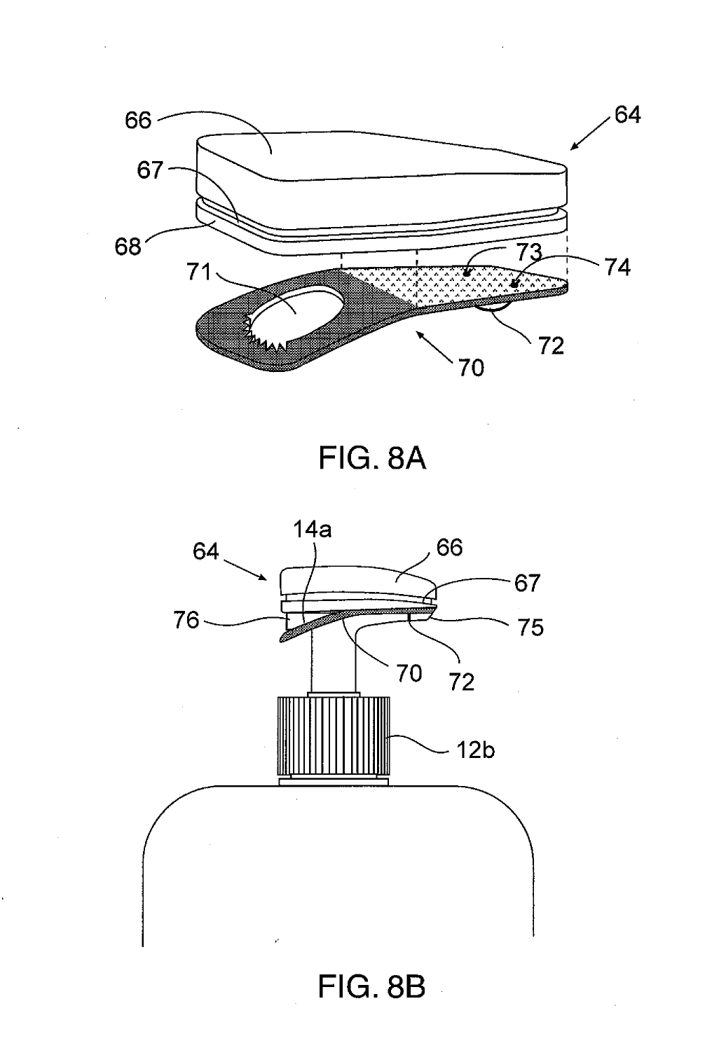

Referring to FIGS. 8a and 8b, the sound emitting device 50 and switch 16 are housed within housing 64 comprising a top section 66 and a bottom section 68 which function in the manner described above with reference to FIGS. 7a and 7b. In this embodiment, the housing 64 is attached to a flexible plate attachment device 70. Plate attachment device 70 is formed of a stretchable material that permits its attachment to plate 14a of pump 12b. Plate attachment device 70 and housing 64 are secured together by any conventional means such as adhesive, nails, Velcro or the like. The plate attachment device 70 includes a hole 71 and line such as a string, thread or the like 72 secured to the device 70 such as by tied knots 73 and 74. String 72 can be stretchable or non-stretchable. In use, the string 72 is positioned over the front end 75 of plate 14a. The device 70 then is stretched to position it over the back 76 of plate 14a. When it is desired to remove housing 64 from plate 14a, the device 70 is stretched to remove the hole 71 and string 72 from the plate 14a. This embodiment permits reuse of the sound emitting device of the invention from container to container.

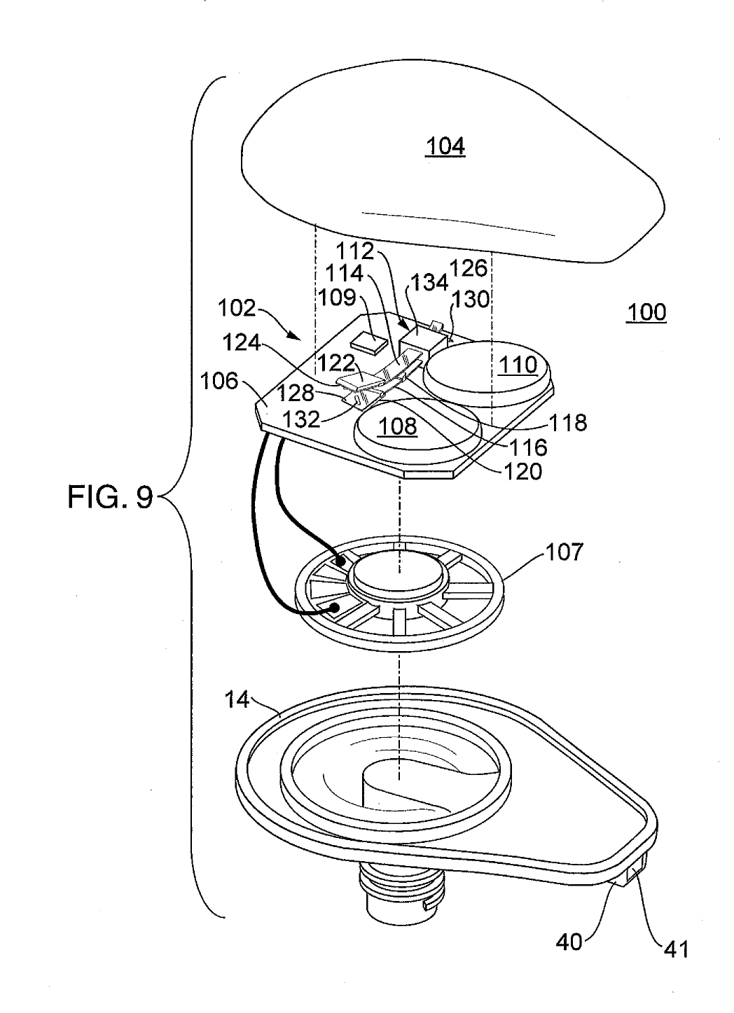

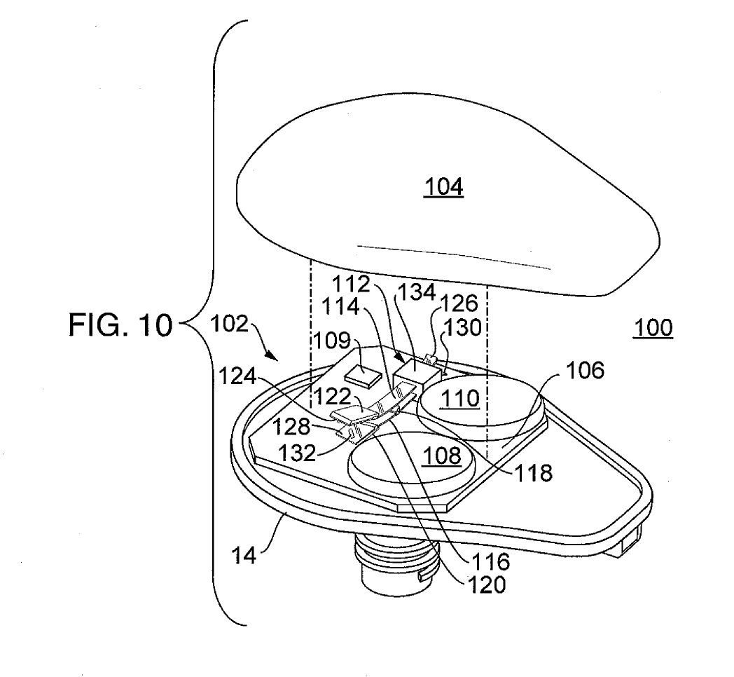

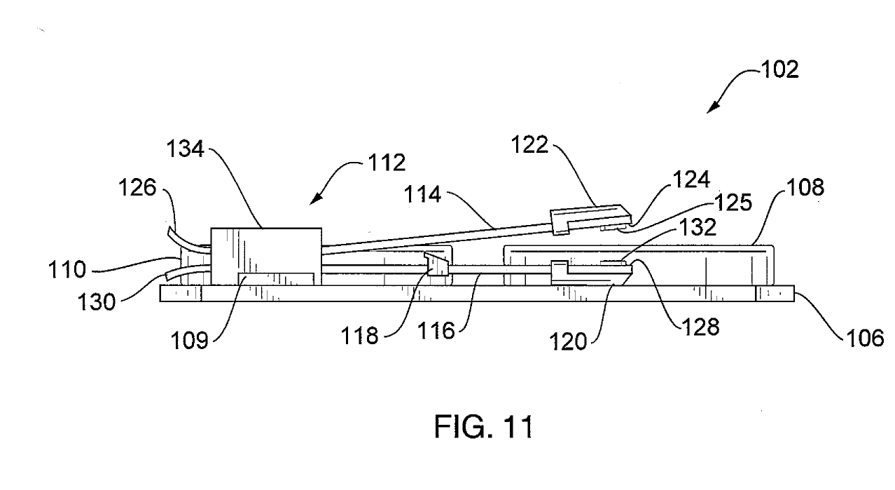

A second embodiment of the invention is shown in FIGS. 9-12. The second embodiment of the invention is a sound emitting fluid dispenser 100 including the plate 14, an actuation mechanism 102 and a pliable cap 104. The actuation mechanism 102 includes a circuit board 106, a speaker 107, a first battery 108, a second battery 110 and an actuator 112. The actuation mechanism 102 is supported on the plate 14. The speaker 107 is coupled to a sound chip 109 connected to or forming part of the circuit board 106. The functioning of the speaker is controlled by the sound chip 109 and the circuit board 106. The speaker is electrically coupled to the first battery 108 and the second battery 110 for power. When the sound chip 109 is activated, sound is emitted by the dispenser 100 through the speaker 107. The speaker 107 is representative of any sort of device configured to emit sounds based on the reception of electrical signals. Any type of integrated circuit capable of generating sound known to those of skill in the art is suitable to perform the function of the sound chip 109.

The actuator 112 includes a first contact bar 114, a second contact bar 116, a fulcrum 118, a contact base 120 and a contact lever 122. The first contact bar 114 includes a first end 124 joined to the contact lever 122 and a second end 126. The second contact bar 116 includes a first end 128 joined to the contact base 120 and a second end 130. The second end 126 of the first contact bar 114 and the second end 130 of the second contact bar 116 are each coupled to separate electrical connectors respectively coupled to the circuit board 106 and, indirectly, to the speaker 107 and the batteries 108 and 110. The fulcrum 118 provides the means to enable the first contact bar 114 and the second contact bar 116 to complete a circuit with relatively modest force applied to the contact lever 122. That is, the fulcrum 118 performs the mechanical advantage generally associated with fulcrums for levers. Its position with respect to the first end 128 and the second end 130 of the second contact bar 116 is selectable. Additionally, the fulcrum 118 or an equivalent may alternatively or additionally joined to the first contact bar 114.

The first end 124 of the first contact bar 114 includes a first contact rib 125 and the first end 128 of the second contact bar 116 includes a second contact rib 132. The first contact rib 125 and the second contact rib 132 complete the circuit between the first contact bar 114 and the second contact bar 116 when the first contact bar 114 is forced toward the second contact bar 116 through movement of the contact lever 122. When the circuit between the first contact bar 114 and the second contact bar 116 is completed by contact of the first contact rib 125 with the second contact rib 132, the batteries 108 and 110 provide current sufficient to activate the operation of the sound chip 109 based on signals generated by the circuit board 106 for the purpose of generating electrical signals to induce sound emissions from the speaker 107. The invention is configured such that once that circuit has been completed, a sound file contained in the sound chip 109 will play through to completion whether or not the pressure has been released from the pliable cap 104.

The first end 124 of the first contact bar 114 is positioned on an underside of the contact lever 122. The contact lever 122 is arranged to extend above the plane of any other devices coupled to circuit board 106. This is achieved in the present invention by using as the first contact bar 114 a material and/or configuration that may be angled, spring-loaded or otherwise arranged to increase the spacing between the first contact bar 114 and the second contact bar 114 from the direction of bar retention block 134 toward first ends 124 and 128 and maintain that spacing except when the contact lever 122 is intentionally loaded. The contact lever 122 and the pliable cap 104 are configured such that they are either always in contact with each other or are at least in close proximity to one another. Thus, when any pressure is applied to the pliable cap 104 in the general vicinity of the contact lever 122, the contact lever 122 is forced to move in a direction toward the second contact bar 116. When sufficient pressure has been applied, the first contact rib 125 of the first contact bar 114 makes contact with the second contact rib 132 of the second contact bar 116 to complete the sound emitting circuit as described. The fulcrum 118 and the configuration of the first contact bar 114 limit the possibility of any inadvertent short circuiting. The pressure applied to the pliable cap 104 that is required to ensure completion of the sound generating circuit should also be enough to depress the plunger used to operate the pump to cause the fluid within the container 10 to be dispensed through outlet 41 as previously described. Optionally, a person may apply enough pressure to activate the sound chip 109 without depressing the plunger enough to dispense the fluid.

The contact base 120 and the contact lever 122 are preferably fabricated of electrically insulative material, such as one or more nonmetallic materials, for example, including, but not limited to, a plastic material or materials with sufficient rigidity to maintain contact bar separation except when the actuation mechanism 100 is operated. The first contact bar 114 and the second contact bar 116 are preferably fabricated of conductive material, such as one or more metallic materials, for example, including, but not limited to, steel. As earlier noted, in order to establish a lever arrangement, the first contact bar 114 is preformed with a bend, curvature or other form of configuration that induces separation between the first end 124 of the first contact bar 114 and the first end 128 of the second contact bar 116 when the pliable cap 104 is not under pressure. The first contact bar 114 is configured with physical properties, including spring characteristics, so that the desired separation between the first contact bar 114 and the second contact bar 116 is substantially maintained over repeated cycles of liquid dispensing, while at the same time is flexible enough to enable that contact with the type of pressure ordinarily applied to a liquid dispenser, including the pressure that a child can generate. In one example of this embodiment of the invention, a steel bar that is approximately one millimeter thick is suitable to establish the desired spring characteristics of the first contact bar 14.

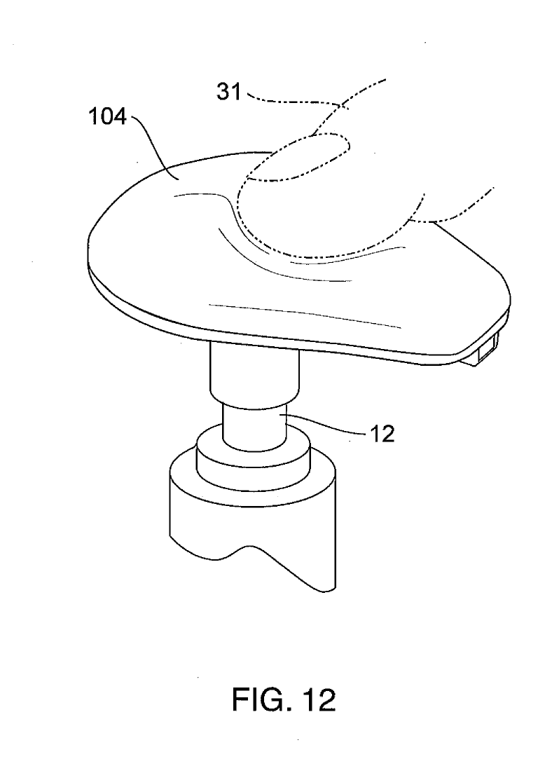

The pliable cap 104 is arranged for placement over the plate 14 to contain the actuation mechanism 102 therein. The pliable cap 104 is preferably made of a pliable material that has some feel and give to it, yet includes sufficient structural characteristics to enable movement of the contact lever 122 when pressure is applied to the pliable cap 104. The pliable cap 104 may be made of a nonmetallic material, such as a viscoelastic material, for example, including, but not limited to, polypropylene. The pliable cap 104 may be fabricated of any desirable shape including, but not limited to, the tapered shape shown in FIGS. 9-10 and 12. As shown in FIG. 12, the pliable cap 104 has physical characteristics such that the application of pressure in one area does not cause movement of the entire cap 104, as is the case with a cap made of a relatively more rigid material. In this way, pressure has to be applied in the appropriate general area of the contact lever 122 to ensure that the circuit has been established, the sound will be generated and the fluid will be dispensed.

While the description of the invention has described the use of a sound chip such as the sound chip 109 to generate sounds, such as music, for example, it is to be understood that any sort of file storage means may be employed to retain sounds of interest to be generated upon operation of the device. For example, a computer chip such as a voice chip, a VAG Chip (Voice, Audio Generator Chip) or any other type of audio storage device suitable joining to the circuit board and the speaker contained under the cap may be employed to store for access any type of sound of interest. The present invention may use any sort of audio storage means. Further, while the second embodiment of the invention refers to the use of two batteries, it is possible to power the device with any number of batteries including, but not limited to, a single battery.

The present invention has been described with reference to several specific embodiments. Nevertheless, it is to be understood that various modifications may be made without departing from the spirit and scope of the invention. All equivalents are deemed to fall within the scope of this description of the invention.

1. A sound emitting fluid dispenser comprising:
a plate for supporting a circuit board thereon, wherein the plate includes a first conduit being in fluid communication with a second conduit and the second conduit is connected to a reciprocator for reciprocating the second conduit in response to pressure applied to the plate;
a sound emitting device coupled to the circuit board;
a pliable cap arranged for placement on the plate; and
an actuator coupled to the circuit board, wherein the actuator is adapted to activate the sound emitting device in response to the application of pressure on the pliable cap.

2. The sound emitting fluid dispenser of claim 1 wherein the actuator includes a lever arm.

3. The sound emitting fluid dispenser of claim 2 wherein the actuator further includes a first contact bar spaced from a second contact bar, wherein the first contact bar forms part of the lever arm such that pressure applied to the pliable cap causes movement of the lever arm until the first contact bar contacts the second contact bar.

4. The sound emitting fluid dispenser of claim 3 wherein the first contact bar and the second contact bar are made of Aluminum.

5. The sound emitting fluid dispenser of claim 4 wherein the first contact bar is fabricated with a bend to establish the lever arm.

6. A device for delivering a fluid and for emitting a sound in conjunction with delivering the fluid, the device comprising:
a container for the fluid;
a plate for supporting a circuit board thereon, wherein the plate includes a first conduit being in fluid communication with a second conduit and the second conduit is connected to a reciprocator for reciprocating the second conduit in response to pressure applied to the plate;
a sound emitting device coupled to the circuit board;
a pliable cap arranged for removable placement on the plate;
an actuator coupled to the circuit board, wherein the actuator is adapted to activate the sound emitting device in response to the application of pressure on the pliable cap; and
means for securing the plate to the container while positioning the second conduit within the container.

7. The device of claim 6 wherein the actuator includes a lever arm.

8. The device of claim 7 wherein the actuator further includes a first contact bar spaced from a second contact bar, wherein the first contact bar forms part of the lever arm such that pressure applied to the pliable cap causes movement of the lever arm until the first contact bar contacts the second contact bar.

9. The device of claim 8 wherein the first contact bar and the second contact bar are made of Aluminum.

10. The device of claim 9 wherein the first contact bar is fabricated with a bend to establish the lever arm.
